(19) United States
(12) Patent Application Publication
(10) Pub. No.: US 2022/0207395 A1
(43) Pub. Date: Jun. 30, 2022

(54) INTERACTIVE INTERVENTION PLATFORM

(71) Applicant: Accenture Global Solutions Limited, Dublin (IE)

(72) Inventors: David William Vinson, San Francisco, CA (US); Matthew Thomas Short, San Jose, CA (US); Sunil Shettigar, Santa Clara, CA (US); Kahlil Gibran Fitzgerald, Richmond, CA (US); Michael Kuniavsky, San Francisco, CA (US)

(21) Appl. No.: 17/560,511

(22) Filed: Dec. 23, 2021

Related U.S. Application Data
(60) Provisional application No. 63/132,005, filed on Dec. 30, 2020.

(51) Int. Cl. G06N 5/04

(52) U.S. Cl. CPC G06N 5/04

(57) ABSTRACT

This document describes a platform that processes multi-modal inputs received from multiple sensors and initiates actions that cause the user to transition to a target state. In one aspect, a method includes detecting, based on data received from sensors, a current state of a user. A set of candidate states to which the user can transition from the current state is identified based on the current state. A target state for the user is selected based on the data received from the sensors and/or the current state of the user. For each of multiple candidate states, a probability at which the user will transition from the current state to the target state through the candidate state is determined. A next state for the user is selected based on the probabilities. One or more actions are determined and initiated to transition the user from the current state to the next state.

### CROSS-REFERENCE TO RELATED APPLICATIONS

This application claims the benefit of U.S. Patent Application No. 63/132,005, filed Dec. 30, 2020, which is incorporated herein by reference.

### TECHNICAL FIELD

This specification relates to data processing and using trained machine learning models to initiate intervening actions.

### BACKGROUND

Some platforms can receive, interpret, and respond to voice commands. For example, intelligent virtual assistants can perform actions in response to voice commands or questions. These assistants can use natural language processing to understand the speech input and then map the speech input to an executable command. When a particular speech input is detected, the assistant can perform the corresponding response.

### SUMMARY

This specification generally describes a platform that processes multi-modal inputs received from multiple sensors and initiates actions that cause transitions to preferred, but low probability, target states. The platform can use the inputs to determine a current state of a user and/or to select a target state to which to transition the user. For example, the platform can determine that a tired user would benefit from being in a relaxation state and initiate actions that help guide the user into that relaxation state. In some cases, the platform can select a sequence of states that will guide the user from the current state to the target state and initiate actions that guide the user through the sequence of states.

In general, one innovative aspect of the subject matter described in this specification can be embodied in methods that include the actions of detecting, based on data received from sensors, a current state of a user; identifying, based on the current state of the user, a set of candidate states to which the user can transition from the current state; selecting, based on one or more of the data received from the sensors or the current state of the user, a target state for the user; for each of multiple candidate states, determining a probability at which the user will transition from the current state to the target state through at least the candidate state; selecting, based on the determined probabilities, a next state for the user; determining one or more actions to transition the user from the current state to the next state; and initiating the one or more actions. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In some aspects, selecting the target state for the user includes selecting a particular candidate state for which a probability of the user transitioning from the current state to the particular state is less than a threshold.

In some aspects, selecting the target state for the user includes selecting a state that is absent from the set of candidate states. In some aspects, determining the probability at which the user will transition from the current state to the target state through at least the candidate state includes determining a probability at which the user will transition from the current state to the target state through a sequence of candidate states including the candidate state.

Some aspects include determining, based on updated data received from the sensors, that the user has transitioned from the current state to the next state, updating the probability for each candidate state based at least on the next state, selecting an additional next state based on the updated probabilities, and initiating one or more additional actions to transition the user from the next state to the additional next state.

Some aspects include, after initiating the one or more actions, determining, based on updated data received from the sensors, that the user is performing actions to prevent the transition to the next state and in response to determining that the user is performing actions to prevent the transition to the next state, stopping the one or more actions or performing one or more additional actions to maintain the user in the current state. Some aspects include determining to transition the user to the target state based at least on the data received from the sensors.

The subject matter described in this specification can be implemented in particular embodiments and may result in one or more of the following advantages. The platforms described in this document can process inputs from various different types of sensors to determine a current state of the user and to determine probabilities that a user will transition to other states and uses those probabilities to initiate actions that guide the user into a preferred state, which is also referred to in this document as a target state. This proactive approach can use a sequence of actions to guide the user into new states previously unknown to the user, target states that benefit the user, and/or states that would provide the user with additional information that would otherwise not be found by the user. Transitioning users to new states previously unknown to them can add to the state space for the user, which can constitute new possible knowledge or experiences for the user or new information for a system, e.g., a telemedicine device gathering new information to diagnose a patient that would otherwise not be obtained absent the described platforms.

Artificial intelligence or other machine learning techniques, e.g., using trained machine learning models, can be used to determine, based on the user's current state (e.g., based on inputs from multiple sensors), a sequence of states that are most likely to result in the user transitioning to the target state. The platform can then use the sequence to initiate actions that seamlessly guide the user into the target state although the target state may be a low probability state for the user, e.g., having a probability that is less than a specified threshold or a state that is not even in the user's state space of potential candidate states. In some instances, the intervention model may learn over time (e.g., based on optimization) that certain sequences are more likely to result in a target state than others. This can improve the performance of the system by reducing the number of actions that are performed to result in the transition, which can also reduce the amount of processing of the model to select actions. This can reduce the amount of computational resources required to achieve transitions, for example, by reducing the number of processor cycles used to select actions, the amount of memory consumed in processing the model, etc.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example environment in which an interactive intervention platform initiates actions to cause a user to transition into a target state.

FIG. 2 shows the interactive intervention platform of FIG. 1 in more detail.

FIG. 3 is a flow diagram of an example process for initiating an action to cause a user to transition to a target state.

FIG. 4 is a block diagram of a computing system that can be used in connection with computer-implemented methods described in this document.

Like reference numbers and designations in the various drawings indicate like elements.

### DETAILED DESCRIPTION

This specification generally describes a platform that receives multi-modal inputs from multiple types of sensors, determines a current state of the user based on the inputs, and initiates actions to guide the user into a preferred state. The platform can be used in various interactive contexts, such as with an interactive assistant/diagnostic device interacting with a patient, in autonomous vehicles controlling an environment for a passenger user, with an interactive display or robot that is interacting with visitors in a recreational area, and/or in other appropriate environments.

The platform can generate interactive experiences for the user. An interactive experience can include, for example, an animated character or video of a real person engaging in conversation with a user. For example, an interactive experience can include multiple scripted conversations from which a particular scripted conversation can be selected based on contextual information. Although scripted, the platform can take the conversation in different directions based on responses from the person(s). In this way, people can have unique experiences depending on context and their interactions (e.g., actions or responses).

The platform can intervene with the state of the user, e.g., if the platform determines that another state is a preferred state for the user. The platform can select a target state for a user based on, for example, the user's current environment, the current state of the user in that environment, characteristics of the user, previous behavior of the user and/or other users, and/or other signals, as described in this document. In an autonomous vehicle example, the platform can determine based on various signals that the user is in a tired state and should rest during transit. In this example, the platform can initiate actions that guide the user into a relaxation state, e.g., by raising the temperature in the vehicle, raising or lowering shades to cover the windows, playing relaxing music, etc.

The target state can be a state that is not in the user's state space, a state that is a low probability state for the user, or a new state for an interactive experience that a system designer wants users to engage. Continuing the previous example, the user may be interacting with a mobile device while sitting in a seat of the vehicle after a long flight. Such a user may have a low probability, e.g., less than a specified probability, of transitioning to a relaxed or sleep state although the relaxed or sleep state may be the best state for the user after a long flight. In a clinical diagnostic environment, a user's state space may not include providing certain information that may be pertinent to a diagnosis of a rare condition. In this example, the platform can cause a virtual doctor shown on a display to ask questions that guide the user into the state to provide that information.

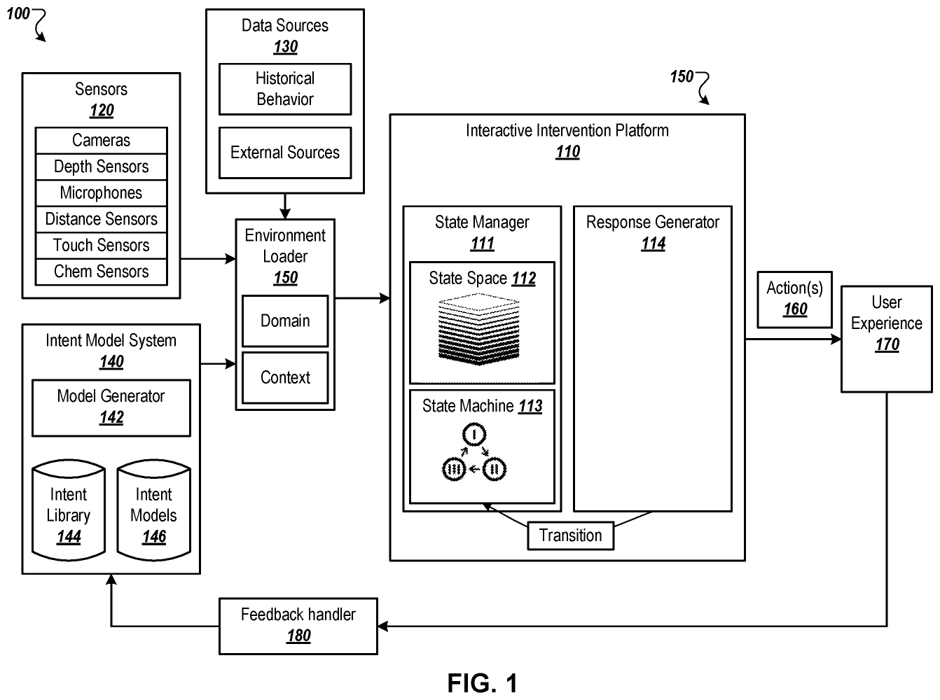

FIG. 1 is an example environment 100 in which an interactive intervention platform 110 initiates actions to cause a user to transition into a target state. The example environment 100 includes sensors 120, data sources 130, and an intent model system 140 that provide data to the interactive intervention platform 110 by way of an environment loader 150. The sensors 120 and data sources 130 can vary based on the environment in which the interactive intervention platform is deployed. For example, the sensors 120 in an autonomous vehicle can differ from those of a movie theater.

The sensors 120 can include, for example, one or more cameras, e.g., one or more RBG cameras, one or more depth cameras, one or more microphones, one or more distance or depth sensors, one or more touch sensors, and/or one or more chemical sensors. The sensors 120 can be installed and configured to monitor a user and/or the user's environment. For example, a camera and microphone can be installed on the front of a robot or interactive display to capture images and voice of the user during an interactive session, e.g., medical conversation or conversation about a movie that the user just watched, with the user. Each sensor can provide output data to the environment loader 150, e.g., periodically or in response to requests received from the environment loader 150.

The data sources 130 can include historical behavior data for the user and/or other users. This historical data can include time series data that indicates actions performed by the user(s) in particular environments, recent actions of the user that can be used to determine the current environment of the user, and/or detected moods and/or states of the user. For example, the historical data can indicate that the user has been in pain for the last two hours (e.g., following a surgery) or that the user recently finished a brisk walk (e.g., from an airport to an autonomous vehicle).

The historical data can also include data indicating how the user and/or other users responded to particular actions. For each action, the historical data can include the environment, e.g., domain and context as described below, in which the action occurred and/or the state of the user at the time that the action occurred. For example, the historical data for a user can indicate that a passenger in the back seat of an autonomous vehicle fell asleep when the temperature was raised or the windows were blocked while the user was in a tired stated. In this example, the passenger is an example of contextual information, the autonomous vehicle is an example of a domain, falling asleep is an example of a response, and raising the temperature and the blocking the windows are examples of actions. This historical data can be determined and stored by the environment loader 150, e.g., based on an analysis of the data received from the sensors 120.

The data sources 130 can include external data sources that are external to the interactive intervention platform 110, e.g., data sources of third parties different from the user and an entity that creates and provides the interactive intervention platform 110. These external data sources can include data sources permitted by the user. For example, an external data source can include an electronic calendar of the user that indicates scheduled appointments, travel plans, meetings, etc. for the user and the user can provide access to this data. Another example data source can be flight data indicating when flights depart and arrive and their scheduled departures and arrivals. Another example data source can be the schedule for a business or service provider, e.g., a movie schedule for a theater or a surgical schedule for a hospital. The environment loader 150 can include interfaces that collect data from the various data sources 130.

The intent model system 140 includes a model generator 142 that generates intent models for determining the environment of the user and/or the intent of the user in the environment based on data received from sensors 120 and data sources 130. The environment of the user can include a domain and/or a context. The domain can be the current physical domain of a user, e.g., in a hospital, movie theater, autonomous vehicle, etc. The context can indicate the user's role, place, or situation within that domain, e.g., a patient, medical professional, or guest at the hospital, or a passenger of the autonomous vehicle, etc. The domain and context can be coarse or fine grained, e.g., an adult in an emergency room or a cardiac patient in a stress lab, depending on the amount and/or types of data available.

An intent of the user can be a state of the user, which corresponds to the intention of the user when the user is in that state. An example state of a user in an autonomous vehicle may be “working” when the user is working on a mobile device (e.g. mobile phone or computer). Another state of a user in an autonomous vehicle may be relaxing, e.g., when the user is reclined or gazing out the window and the intent of the user is to rest. The state space of a user can include multiple states that the user can be in when in a particular environment and each state can correspond to an intent that indicates the intention of the user when in that state.

The model generator 142 can generate one or more intent models, e.g. using artificial intelligence or other machine learning techniques, for determining an environment of a user and/or the intent of the user in the environment. For example, the model generator 142 can train a machine learning model to determine or predict an environment of a user and/or the intent of a user in the environment using training data collected from sensors 120 and/or data sources, and optionally labels for the training data. The labels can specify the intent of a user corresponding to the sensor data and/or the environment, e.g., domain and/or context, from which the sensor data was received. The model generator 142 can train overall intent models that can be used in various types of domains or domain-specific models (e.g., one for hospitals and one for movie theaters). The model generator 142 can store the intent models in an intent model data storage device 146.

Each intent, or its corresponding state, can be mapped to one or more actions that are initiated and/or performed by the interactive intervention platform 110, e.g., when the user is detected to have that intent. In other words, when the interactive intervention platform 110 detects that a user is in a particular state corresponding to a particular intent, the interactive intervention platform 110 can initiate and/or perform the action(s) corresponding to the intent. However, as described in more detail below, the interactive intervention platform 110 can intervene with the user's state and initiate actions that guide the user into a different, target state. The mapping of intents to actions can be included in an intent library 144, which can be stored in a data storage device. In some implementations, a system designer can map the intents to their corresponding actions.

The intent library 144 can include a respective set of intents and their corresponding actions for each of multiple different environments. For example, the library of intents can include a set of intents and actions for adult cardiac patients, which may be different from a set of intents and actions for pediatric patients, both of which may be different from a set of intents and actions for a passenger in an autonomous vehicle. In this example, the questions that would be asked to the different types of patients can vary and a virtual medical assistant that asks the questions can be different, e.g., an animated character for a child or a lifelike character or video of an actual doctor for an adult. In this example, the actions can specify the characters/personas used to deliver the actions.

As an example, the intent library 144 can include a set of intents and corresponding actions for an autonomous vehicle. Some example intents can be “provide directions,” “provide destination,” “interact with mobile device,” “ask question,” and “sleep.” The action that is performed when the “provide destination” intent is detected can be to monitor for the destination, e.g., capture audio and determine whether the audio matches an actual location, and to confirm destination to the user, e.g., by playing confirmation audio back to the user. The action that is performed when the “sleep” intent is detected can be to lower any audio or adjust the temperature to allow the user to sleep.

The environment loader 150 can aggregate data received from the sensors 120 and/or the data received from the data sources 130. The aggregation can include correlating time series data with the environment and/or state of the user at each point in time, e.g., to create a sequence of environments and states for the user over time. The environmental loader 150 can use one or more intent models determine, based on the aggregated data, the environment (e.g., context and/or domain) of the user and the intent of the user.

To illustrate a particular example, a camera can capture images of the user and/or the user's environment. The environment loader 150 can analyze the images, e.g., using computer vision techniques, to determine that the images depict an adult in business attire in a seat of a car. The environment loader 150 can also use location data from a location sensor, e.g., a Global Positioning System (GPS) sensor, to determine that the car is moving away from an airport. In this example, the environment loader 150 can determine that the domain is a car and that the context includes a business traveler. In addition, the environment loader 150 can determine, based on the images of the user and a calendar/schedule of the user that the user is in a tired state, e.g., corresponding to an intent to sleep. For example, the environment loader 150 can make this determination based on features of the user's face in the images and the fact that the user has been awake for at least 18 hours based on the user's calendar.

The environment loader 150 can provide data indicating the determined environment and the determined intent to the interactive intervention platform 110, which can be implemented using one or more computers. The interaction intervention platform 110 includes a state manager 110 and a response generator 114. The state manager 111 can manage a state space 112 that includes a set of possible, or candidate, states for the user in the determined environment. The state manager 111 can determine the state space 112 based on the environment and/or the particular user. In some instances, the state space for a given user is determined using the intent library and multimodal capture of various known models to quantify or classify emotions, and actions. For example, there may be a limited number of candidate states for a child as a passenger in an autonomous vehicle. The state space 112 for this user can include this limited number of candidate states. In another example, the state space of the user can include only previous states that the user or other users were detected to be in when the user(s) were in the same environment. The state manager 111 can store the state space 112 for each particular environment or combination of environment and user in a data storage device.

The state manager 111 also includes a state machine 113 that models the transitions between the states in the state space 112. The state machine 113 can define the states within the state space 112 and, for each state, the other states that the user can transition to from that state. The state machine 113 can also define probabilities for transitioning between the states. These probabilities can be static or dynamic based on sensor data 120, data from the data sources 130, e.g., the historical behavior data for the user and/or other users, and/or the domain or context of the environment. For example, the state manager 111 can determine the probabilities based on the number of times, or frequency at which, users transitioned between the states when in the same or a similar environment.

The state manager 111 can track the user's transitions between states using the state machine 113 and updated intent data that indicates the current state of the user received from the environment loader 150. For example, the environment loader 150 can continuously or periodically obtain updated sensor data and data from the data sources, update the intent of the user based on this data, and provide the updated intent data to the interactive intervention platform 110. The environment loader 150 can similarly update the domain and/or context of the user if there are changes detected in the environment.

The response generator 114 can initiate one or more actions based at least in part on the current state of the user. As described above, each intent, which corresponds to a state, can be mapped to one or more actions. When the response generator 114 receives data from the state manager 111 indicating that the user is in a particular state, the response generator 114 can initiate the action(s) mapped to the intent corresponding to the state.

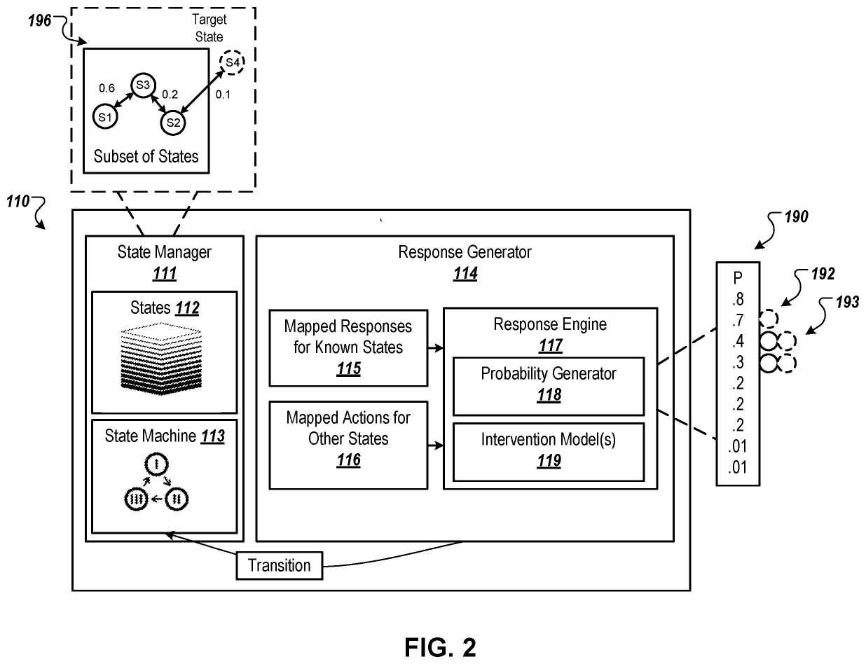

The response generator 114 can also initiate actions 160 to cause the user to transition to a target state, e.g., a preferred, unknown, and/or low probability state for the user. For example, rather than or after performing the action(s) 160 for a particular state, the response generator 114 can determine to guide the user from the user's current state to the target state. Like the intents, each target state can include one or more corresponding actions that are performed when the user is in the state and/or one or more actions 160 that can guide the user into the target state. The actions for transitioning to the target state can vary based on the current state of the user. In this example, each target state can be mapped to one or more actions for each state from which the user can transition to the target state. The state manager 111 and response generator are described in more detail with reference to FIG. 2.

To initiate an action, the interactive intervention platform 110 can send instructions to another component, device, or system to perform the action. For example, if the interactive intervention platform 110 is part of an interactive display that provides interactive experiences 170, the interactive intervention platform 110 can cause the display to present a particular response using a particular character or persona. In another example, if the interactive intervention platform 110 is part of an autonomous vehicle, the interactive intervention platform 110 can activate actuators of the vehicle, e.g., activating a window control to raise or lower the window or send instructions to a media device to raise or lower its audio.

The example environment 100 can also include a feedback handler 180. The feedback handler 180 can collect feedback data, process the feedback data for consumption by the intent model system 140 and provide the feedback data to the intent model system 140. This feedback data can include data from the sensors 120 for determining the user's response to the actions and/or data that can be used to determine whether the environment loader 150 determined the correct environment for the user. For example, a camera can be used to capture a user's facial expression in response to changes to the user's environment. The feedback handler 180 can process the images of the user's face, e.g., to determine that the images indicate surprise or another appropriate emotion or response. The indication of surprise can be fed back into the intent model system 140. The intent model system 140 can compare this response to the expected or target response and update the intent models 146 based on whether the actual response matches the target response. For example, the intent model system 140 can update a probability that a particular action will lead to a transition from one state to another based on whether the user made the transition in response to an action initiated by the interactive intervention platform 110.

The interactive intervention platform 110 can also use the feedback to select a next action. For example, if the feedback indicates that the user did not make an expected transition to a next state, the interactive intervention platform 110 can select another action to guide the user into the transition to the next state. If the user did transition to the next state, the interactive intervention platform 110 can select another action to guide the user to the target state or a next intermediate state before the target state.

FIG. 2 shows the interactive intervention platform 110 of FIG. 1 in more detail. The state manager 111 can select or determine a subset of states that make up the state space 196 of a user in a particular environment. As described above, the state manager 111 can also determine, for pairs of states, a probability that the user will transition between the states. In this example, the state space 196 for a user includes states S1-S3 and there is a 60% probability of the user transitioning between states S1 and S3 and a 20% probability of the user transitioning between states S2 and S3.

There can also be other states that are not within the state space, such as state S4. For example, the state S4 can be a state that the user has never been detected to be in or a state that users in the same or a similar environment as the user's current environment has never been detected to be in. In another example, the states that are not in the state space 196 can be states that have a very low probability of being transitioned into. For example, these other states can have a probability of less than 1%, less than 0.5%, or less than another appropriate threshold. Since states may overlap one another, the state manager 111 can classify a given user's state as a function of its probability across the entire state space.

The response generator 114 includes a response engine 117 that includes a probability generator 118 and intervention models 119. The response engine 117 can receive data indicating mapped actions 115 for the known states, e.g., the states in the state space 196 and mapped responses 116 for other states that are not in the state space 196. The actions 115 and 116 for each state can include one or more actions that the response generator 114 can initiate in response to detecting that the user is in that state.

The actions 115 and 116 for each state can also include actions that can cause the user to transition into the state from another state. As an example, the actions 116 for a given other state can include, for each of one or more known states in the state space 196, one or more actions that can guide the user from the known state to the given other state. For example, assume that the user is determined to currently be in state S2, which corresponds to an interacting with mobile device state and that state S4 is a sleep state that is not within the state space 196 of the user because the user has either a zero or low probability of transitioning to the sleep state. In this example, the actions 116 for the sleep state S4 while the user is in the interacting with mobile device state can include reducing the amount of light in the user's environment (e.g., by moving a shade into position over a window or deactivating a light) or reducing any audio being played by a media device in the user's environment.

The probability generator 118 can determine, for each of multiple candidate states, a probability that the user will transition to a target state from that candidate state. The candidate states can include the states in the state space 196 and/or other states outside of the state space. The probability generator 118 can determine these probabilities based on the user's current state and/or the historical behavior data for users in those candidate states. For example, the probability that a user will transition from a candidate state to the target state can be based on a frequency at which users transitioned from the candidate state to the target state after transitioning from the current state to the candidate state. In such instances, the probability can be determined using frequency-based modeling. In another example, the probability that a user with transition from a candidate state to a target state can be based on that user's previous transitions between those states or other states, e.g., an overall responsiveness of the user to actions that attempt to lead the user between various states.

The response engine 117 can use the probabilities and an intervention model 119 to determine whether to transition the user to a target state and, if so, a sequence of states to guide the user to the target state. The response engine 117 can determine whether to transition the user to a target state based on various criteria, such as the user's current environment, the current state of the user in that environment, previous states that the user has been in while in this environment (e.g., recent states during a current interactive session), characteristics of the user, previous behavior of the user and/or other users, sensor data received from the sensors 120, and/or other appropriate signals. For example, the response engine 117 can determine, based on the user's previous states (e.g., working, checking e-mails, etc.), the fact that the user recently was on a long flight, and images of the user's face that the user is tiring. In this example, the response engine 117 can determine that the user would benefit from a relaxation state or sleep state and, in response, determine to transition the user to the relaxation or sleep state.

The response engine 117 can also use the sensor data to determine that a transition is imminent or possible with some prompting via actions. For example, the response engine 117 can determine, by detecting a particular gesture or eye gaze direction, that the user would be receptive to a nap and, in response, determine that a transition to the sleep state is possible with prompting via changes to the user's environment.

If the response engine 117 determines to transition the user to a target state, the response engine 117 can use the intervention model 119 to determine the actions to guide the user into the target state. The intervention model 119 can be an artificial intelligence or other machine learning model that can be used to select, based at least on probabilities of transitions, whether to transition the user to a target state, to select the target state, and/or to select a path or sequence through one or more states to arrive at the target state. The inputs to such a model can include the probabilities of transitions between candidate states to the target state, the data used to select the target state, and/or other appropriate information. The output can include a next state for the user and/or a sequence of next states for the user. In some instances, the intervention model 119 may learn over time (e.g., based on optimization) that certain sequences are more likely to result in a target state than others.

For example, the response engine 117 can use the intervention model 119 to rank or otherwise order a set of candidate states through which the user can transition from the current state to the target state, as shown in an example ranking 190. This ranking 190 of candidate states can be based on the probability that the user will transition to the target state at least through the candidate state. The probability can be based on the probability that the user will transition from the current state to the candidate state and a probability that the user will transition directly from the candidate state to the target state. The probability can also be based on probabilities for longer paths through multiple states. For example, the ranking 190 shows that there is a 70% probability for a first path 192 in which the user will transition directly from a candidate state to a target state (dashed circle). The ranking 190 also shows that there is a 40% probability that the user will transition from a candidate state to the target state through an intervening state (solid circle).

The response engine 117 can determine whether to initiate a transition to the target state based on the ranking and/or the probabilities of the ranking. For example, the response engine 117 can determine to initiate the transition to the target state if at least one of the probabilities exceeds a specified threshold, e.g., a predetermined threshold. In another example, the response engine 117 can determine whether to initiate the transition based on the at least one probability exceeding the threshold in combination with sensor data. For example, the response engine 117 can determine to initiate the transition in response to the probability exceeding the threshold and a detection, e.g., from image vision processing, that the user has made a gesture or performed some action that indicates that the transition is possible with some prompting.

If the response engine 117 determines to initiate the transition, the response engine 117 can use the intervention model 119 to select the next state and/or a sequence of next states through which to transition the user. In some cases, the next state can be the target state, e.g., in a direct transition. In other cases, the next case can be an intervening state that makes it easier, and therefore more probable, to transition to the target state from the current state. For example, it may be more probable to transition a passenger to a sleep state by first transitioning the user to relaxed state. In another example, it may be more probable to get information about a user's potential exposure to a health condition by transitioning the user through questions about recent activities, including travel to foreign countries.

Once a next state is selected, the response engine 117 can initiate the mapped actions for transitioning the user from the current state to the next state. The state manager 111 can continue monitoring the current state of the user and can alert the response engine 117 when the user transitions to a different state. In addition, the response engine 117 can continue updating the probabilities of transitioning to the target state based on any changes to the user's state or environment. If the user transitions to another state, e.g., to the selected next state, the response engine 117 can repeat the transition determination to determine whether to transition to another state and, if so, which state.

The response engine 117 can also monitor the sensor data for any indication that the user does not want to transition between states, e.g., to the target state. For example, if the target state is a sleep state and the user is interacting with a mobile device, the user may have a critical deadline or otherwise not be able to sleep at that time. The response engine 117 can monitor for cues, e.g., cues learned from machine learning or specified by a user, that the user does not want to transition states. For example, if the action is to reduce lighting to transition the user to a sleep state, a cue can be the user increasing the lighting or making gestures to fight sleep. If the response engine detects an indication that the user does not want to transition states, the response engine 117 an abort the transition or stop the actions from being performed.

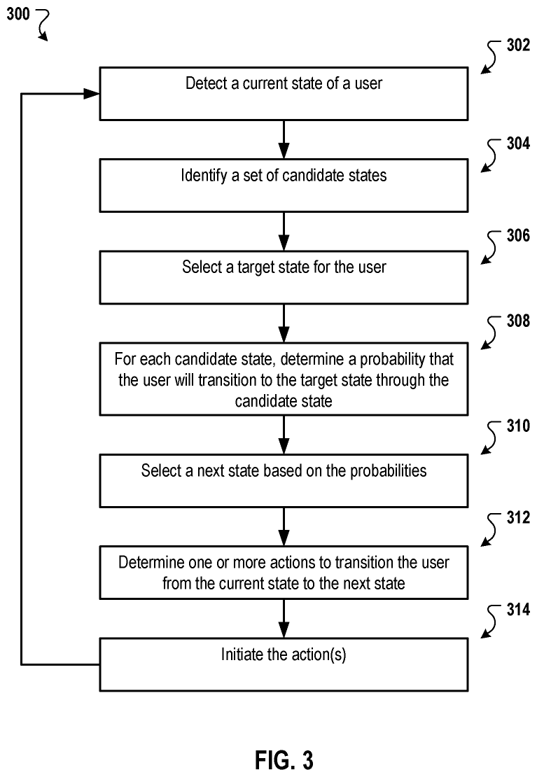

FIG. 3 is a flow diagram of an example process 300 for initiating an action to cause a user to transition to a target state. The process 300 can be performed, for example, by the interactive intervention platform 110 of FIG. 1.

The interactive intervention platform 110 detects a current state of the user (302). The interactive intervention platform 110 can detect the current state of the user using an intent model, sensor data, and data from other sources, as described above.

The interactive intervention platform 110 identifies a set of candidate states for the user (304). The set of candidate states can include states that are within the user's current state space. For example, as described above, the interactive intervention platform 110 can determine the user's state space based on the environment and/or the particular user. In another example, the state space of the user can include only previous states that the user or other users were detected to be in when the user(s) were in the same environment.

The interactive intervention platform 110 selects a target state for the user (306). As described above, the interactive intervention platform 110 can select a target state for the user based on various criteria, such as the user's current environment, the current state of the user in that environment, previous states that the user has been in while in this environment (e.g., recent states during a current interactive session), characteristics of the user, previous behavior of the user and/or other users, sensor data received from the sensors, and/or other appropriate signals.

For each candidate state, the interactive intervention platform 110 determines a probability that the user will transition to the target state through the candidate state (308). The interactive intervention platform 110 can determine these probabilities based on the user's current state and/or the historical behavior data for users in those candidate states. For example, the probability that a user will transition from a candidate state to the target state can be based on a frequency at which users transitioned from the candidate state to the target state after transitioning from the current state to the candidate state.

The probability for a candidate state can be based on the probability that the user will transition from the current state to the candidate state and a probability that the user will transition directly from the candidate state to the target state. The probability can also be based on probabilities for longer paths through one or more intervening states.

The interactive intervention platform 110 selects a next state for the user based at least in part on the probabilities (310). This determination can include determining to initiate the transition, e.g., based on at least one of the probabilities exceeding a specified threshold and/or detecting a cue from the user that indicates that the user is likely to transition to the target state if prompted.

This determination can also include ranking or otherwise ordering the candidate states based on their respective probabilities. The interactive intervention platform 110 can select, as the next state, the candidate state that has the highest probability of transitioning the user to the target state.

The interactive intervention platform 110 determines one or more actions to transition the user from the current state to the selected next state (312). For example, each candidate state can be mapped to a set of actions that can be used to guide the user into the candidate state. As described above, the set of actions can include, for each of multiple potential current states, one or more actions that can transition the user from the potential current state to the candidate state. The interactive intervention platform 110 can access the mapping, e.g., from a data storage device, and select the actions that correspond to the current state of the user and the selected next state for the user.

The interactive intervention platform 110 initiates the actions (314). For example, the interactive intervention platform 110 can perform the actions (e.g., by updating a display to present a selected response) or transmit instructions to another device that implements the action.

After initiating the action(s), the process 300 can return to operation 302 where the interactive intervention platform 110 continues monitoring the state of the user. The interactive intervention platform 110 can also continue updating the probabilities and iterate through the process 300 multiple times until arriving at the target state or detecting an indication that the user does not want to transition from the current state or to the target state.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

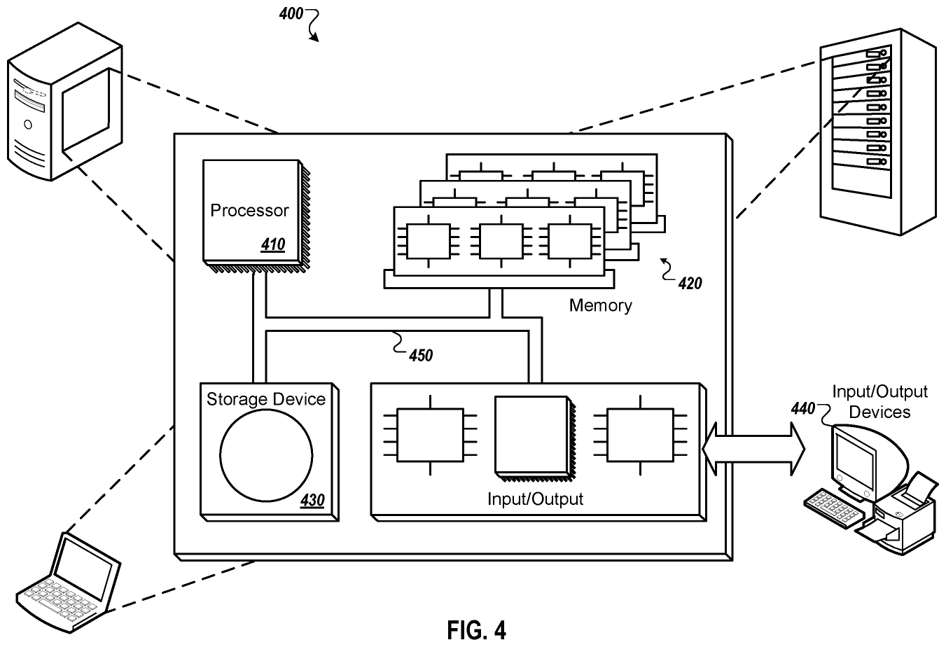

An example of one such type of computer is shown in FIG. 4, which shows a schematic diagram of a computer system 400. The system 400 can be used for the operations described in association with any of the computer-implemented methods described previously, according to one implementation. The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
detecting, based on data received from a plurality of sensors, a current state of a user;
identifying, based on the current state of the user, a set of candidate states to which the user can transition from the current state;
selecting, based on one or more of the data received from the sensors or the current state of the user, a target state for the user;
for each of a plurality of candidate states, determining a probability at which the user will transition from the current state to the target state through at least the candidate state;
selecting, based on the determined probabilities, a next state for the user;
determining one or more actions to transition the user from the current state to the next state; and
initiating the one or more actions.

2. The computer-implemented method of claim 1, wherein selecting the target state for the user comprises selecting a particular candidate state for which a probability of the user transitioning from the current state to the particular state is less than a threshold.

3. The computer-implemented method of claim 1, wherein selecting the target state for the user comprises selecting a state that is absent from the set of candidate states.

4. The computer-implemented method of claim 1, wherein determining the probability at which the user will transition from the current state to the target state through at least the candidate state comprises determining a probability at which the user will transition from the current state to the target state through a sequence of candidate states including the candidate state.

5. The computer-implemented method of claim 1, further comprising:
determining, based on updated data received from the plurality of sensors, that the user has transitioned from the current state to the next state;
updating the probability for each candidate state based at least on the next state;
selecting an additional next state based on the updated probabilities; and
initiating one or more additional actions to transition the user from the next state to the additional next state.

6. The computer-implemented method of claim 1, further comprising:
after initiating the one or more actions, determining, based on updated data received from the plurality of sensors, that the user is performing actions to prevent the transition to the next state; and
in response to determining that the user is performing actions to prevent the transition to the next state, stopping the one or more actions or performing one or more additional actions to maintain the user in the current state.

7. The computer-implemented method of claim 1, further comprising determining to transition the user to the target state based at least on the data received from the plurality of sensors.

8. A computer-implemented system, comprising:
one or more computers; and
one or more computer memory devices interoperably coupled with the one or more computers and having tangible, non-transitory, machine-readable media storing one or more instructions that, when executed by the one or more computers, perform operations comprising:
detecting, based on data received from a plurality of sensors, a current state of a user;
identifying, based on the current state of the user, a set of candidate states to which the user can transition from the current state;
selecting, based on one or more of the data received from the sensors or the current state of the user, a target state for the user;
for each of a plurality of candidate states, determining a probability at which the user will transition from the current state to the target state through at least the candidate state;
selecting, based on the determined probabilities, a next state for the user;
determining one or more actions to transition the user from the current state to the next state; and
initiating the one or more actions.

9. The computer-implemented system of claim 8, wherein selecting the target state for the user comprises selecting a particular candidate state for which a probability of the user transitioning from the current state to the particular state is less than a threshold.

10. The computer-implemented system of claim 8, wherein selecting the target state for the user comprises selecting a state that is absent from the set of candidate states.

11. The computer-implemented system of claim 8, wherein determining the probability at which the user will transition from the current state to the target state through at least the candidate state comprises determining a probability at which the user will transition from the current state to the target state through a sequence of candidate states including the candidate state.

12. The computer-implemented system of claim 8, wherein the operations comprise:
determining, based on updated data received from the plurality of sensors, that the user has transitioned from the current state to the next state;
updating the probability for each candidate state based at least on the next state;
selecting an additional next state based on the updated probabilities; and
initiating one or more additional actions to transition the user from the next state to the additional next state.

13. The computer-implemented system of claim 8, wherein the operations comprise:
after initiating the one or more actions, determining, based on updated data received from the plurality of sensors, that the user is performing actions to prevent the transition to the next state; and
in response to determining that the user is performing actions to prevent the transition to the next state, stopping the one or more actions or performing one or more additional actions to maintain the user in the current state.

14. The computer-implemented system of claim 8, wherein the operations comprise determining to transition the user to the target state based at least on the data received from the plurality of sensors.

15. A non-transitory, computer-readable medium storing one or more instructions executable by a computer system to perform operations comprising:
detecting, based on data received from a plurality of sensors, a current state of a user;
identifying, based on the current state of the user, a set of candidate states to which the user can transition from the current state;
selecting, based on one or more of the data received from the sensors or the current state of the user, a target state for the user;
for each of a plurality of candidate states, determining a probability at which the user will transition from the current state to the target state through at least the candidate state;
selecting, based on the determined probabilities, a next state for the user;
determining one or more actions to transition the user from the current state to the next state; and
initiating the one or more actions.

16. The non-transitory, computer-readable medium of claim 15, wherein selecting the target state for the user comprises selecting a particular candidate state for which a probability of the user transitioning from the current state to the particular state is less than a threshold.

17. The non-transitory, computer-readable medium of claim 15, wherein selecting the target state for the user comprises selecting a state that is absent from the set of candidate states.

18. The non-transitory, computer-readable medium of claim 15, wherein determining the probability at which the user will transition from the current state to the target state through at least the candidate state comprises determining a probability at which the user will transition from the current state to the target state through a sequence of candidate states including the candidate state.

19. The non-transitory, computer-readable medium of claim 15, wherein the operations comprise:
determining, based on updated data received from the plurality of sensors, that the user has transitioned from the current state to the next state;
updating the probability for each candidate state based at least on the next state;
selecting an additional next state based on the updated probabilities; and
initiating one or more additional actions to transition the user from the next state to the additional next state.

20. The non-transitory, computer-readable medium of claim 15, wherein the operations comprise:
after initiating the one or more actions, determining, based on updated data received from the plurality of sensors, that the user is performing actions to prevent the transition to the next state; and
in response to determining that the user is performing actions to prevent the transition to the next state, stopping the one or more actions or performing one or more additional actions to maintain the user in the current state.

21. The non-transitory, computer-readable medium of claim 15, wherein the operations comprise determining to transition the user to the target state based at least on the data received from the plurality of sensors.
